(19) United States
(12) Patent Application Publication
(10) Pub. No.: US 2002/0107057 A1
(43) Pub. Date: Aug. 8, 2002

(54) Harvester for small fallen fruits

(76) Inventors: Bernard Granger, Saint-Jean-sur-Richelieu (CA); Roger Chagnon, Saint-Mathias-sur-Richelieu (CA); Eric Saint-Denis, Sainte-Rosalie (CA); Benoit Lacasse, Saint-Jean-sur-Richelieu (CA)

Correspondence Address: ROGER CHAGNON, AGRICULTURE AND AGRI-FOOD CANADA, 430 BOUL. GOUIN, SAINT-JEAN-SUR-RICHELIEU, QC, J3B 3E6, CA

(21) Appl. No.: 09/777,050

(22) Filed: Feb. 6, 2001

(51) Int. Cl. A01D 46/00

(52) U.S. Cl. 460/123

(57) ABSTRACT

A harvester for small fallen fruit is adapted to a conventional self propelled farm vehicle chassis moving over a row of planted shrubs with a system of long protruding rods that lifts up the leaves and branches of the fruit bearing shrubs, thus clearing the way for a pair of elongated rotating sweepers with one positioned to be running at one side of the row of shrubs and the other so positioned as to be on the opposite side of the same row of shrubs and each positioned to collect the fallen fruits from the surface of the plastic mulch and each of the elongated rotating brush directs the fruits into the mouth of its own dedicated air duct which propels the fruits into a cleaning unit that removes dirt, dust, leaves and twigs from the fruits before they fall into a collector bin.

### BACKGROUND OF THE INVENTION

The invention is a harvester that gathers small fruits that have fallen off the branches of fruit bearing shrubs.

1. Field of the Invention

The invention relates to harvesters in general but more particularity to harvesters that use various windrowing techniques to gather up fallen fruits for easy harvesting.

2. Description of the Relevant Art

A wide variety of farming machinery has been developed to help in the harvesting of all kinds of fruits and vegetables. Some date as far back as 1895 with U.S. Pat. No. 532,079. Generally, the machine in this patent and others as well, describe horizontal conveyor members directing fruits to a specific location. Because of the wide variety of shapes in the foliage plus the size, shape, fragility and countless other variables, a machine developed for one kind of plant or tree may not be suitable for another. It is therefore necessary to modify some elements in the overall machine in order to maximize the harvest yield of the machine. There are harvesters that were developed for small bushy fruit bearing plants but none appear to have all of the features to provide for a truly efficient machine. For example, patent U.S. Pat. No. 4,984,421 by Dreux describes a machine that can gather, from the ground, a variety of fruit types including small fragile fruits. However, this particular machine is unsuitable for working around small bushes. U.S. Pat. No. 3,981,127 by Smith, besides having the same drawback of not being suitable for working around small bushes, describes the use of a series of rectangular modules that actuate tines but which may not be suitable for small fragile fruits. Most of these arguments also apply to patent U.S. Pat. No. 3,879,923 by Granger which uses a number of rectangular rotating belts to gather or windrow fruits toward the middle in order to create a row of fruits. U.S. Pat. No. 4,706,447 by Watmough comprises a combination of three different means for conveying fruits at least two of which could result in severe damage to delicate fruits. U.S. Pat. No. 4,970,850 by DeVries describes a system appropriate for small fruits but it picks the fruits directly off of the branches by using a beating mechanism.

### SUMMARY OF THE INVENTION

The purpose of this invention is to provide an efficient harvester designed for low lying bush-like plants bearing small fruits grown on plastic mulch.

It is an object of the invention to provide an efficient means of picking small fallen fruits by elevating the leaves and branches of the shrubs to make it easier to pick up fruits.

It is another object of the invention to have low profile, elongated rotating sweepers situated in the vicinity of the ground so that the leaves are not raised too much in order to reduce the damage to the shrubs.

It is yet another object of the invention to remove the fruits from the plastic mulch without breaking it to enable multiple harvests in the same row as the fruits mature over time.

It is yet another object of the invention to be able to efficiently collect the fruits even if the terrain is uneven.

It is yet another object of the invention to provide for an efficient air blowing system which sends fruits into a net which is part of a cleaning unit and said net separates dirt and dust from the fruit with minimal damage to the fruits.

It is yet another object of the invention to use an inclined conveyor belt as part of the cleaning unit to remove leaves and twigs from the fruits before they fall into a collector bin while causing minimal damage to the fruits. The fruits roll down the conveyor belt until they reach the collector bin located at the bottom end while the leaves and twigs lay on the belt until they are discharged at the upper end of the belt.

Finally, it is an object of the invention to provide easily dismantled parts using off-the-shelf components for easy repairs in the field.

To accomplish that, this invention is adapted to a conventional self propelled farm vehicle chassis. Moving over a row of planted shrubs, a system of long protruding rods lifts up the leaves and branches of the fruit bearing shrubs, thus clearing the way for a pair of elongated rotating sweepers with one positioned to be running at one side of the row of shrubs and the other so positioned as to be on the opposite side of the same row of shrubs and each positioned to collect the fallen fruits from the surface of the plastic mulch and each said elongated rotating brush directs the fruits into the mouth of its own dedicated collector duct which propels the fruits into a cleaning unit that removes dirt, dust, leaves and twigs from the fruits before they fall into a collector bin.

### DESCRIPTION OF THE DRAWINGS

FIG. 1 Is a perspective view of the invention as it relates to a conventional self propelled farm vehicle chassis

FIG. 2 Is a perspective view showing the detail of the elongated rotating sweepers and the vacuum mouth.

FIG. 3 Is a side elevation showing details of the elongated rotating sweepers and the vacuum mouth.

FIG. 4 Is a perspective view of the detail of the elongated rotating sweepers.

### DETAILED DESCRIPTION OF THE PREFERRED EMBODIMENT

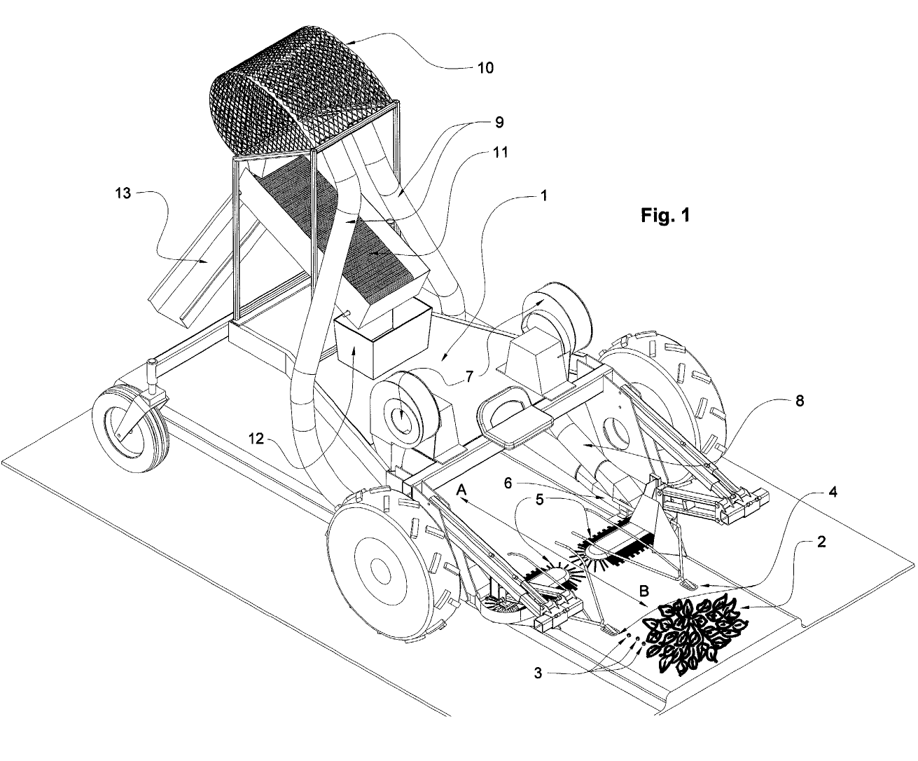

FIG. 1A conventional self propelled farm vehicle chassis 1, shown generally, moves up and down rows of planted fruit bearing shrubs 2, picking up fallen fruits 3 as it goes. To do the actual picking, an assembly comprised of a system of long protruding rods 4 lifts leaves and branches of the shrubs as the farm vehicle chassis 1 moves forward. That lifting action, combined with the inherent vibrations of the long protruding rods 4 created by the farm vehicle chassis 1 causes additional fruits to fall off the branches. With the branches and leaves out of the way, a pair of elongated rotating sweepers 5 gather the fallen fruits 3 and directs them towards their respective vacuum mouth 6 (only one visible). There, compressed air, produced by fans 7 and coming down through air ducts 8 propels the fruits 3 (not identified here)up into a set of collector ducts 9, which are separate and distinct from the air ducts 8, this way, the path of the fruits 3 is never in the path of the fans, as would be the case if vacuum suction would have been used. At the other end of the collector ducts 9 is a cleaning net 10 which separates dust and dirt from the said fruits 3. From there, the fruits 3 tumble onto an inclined conveyor belt 11 and finally, they roll off to the bottom into a collector bin 12. Meanwhile, leaves and twigs are carried up and over the conveyor belt 11 to be discharged down a chute 13.

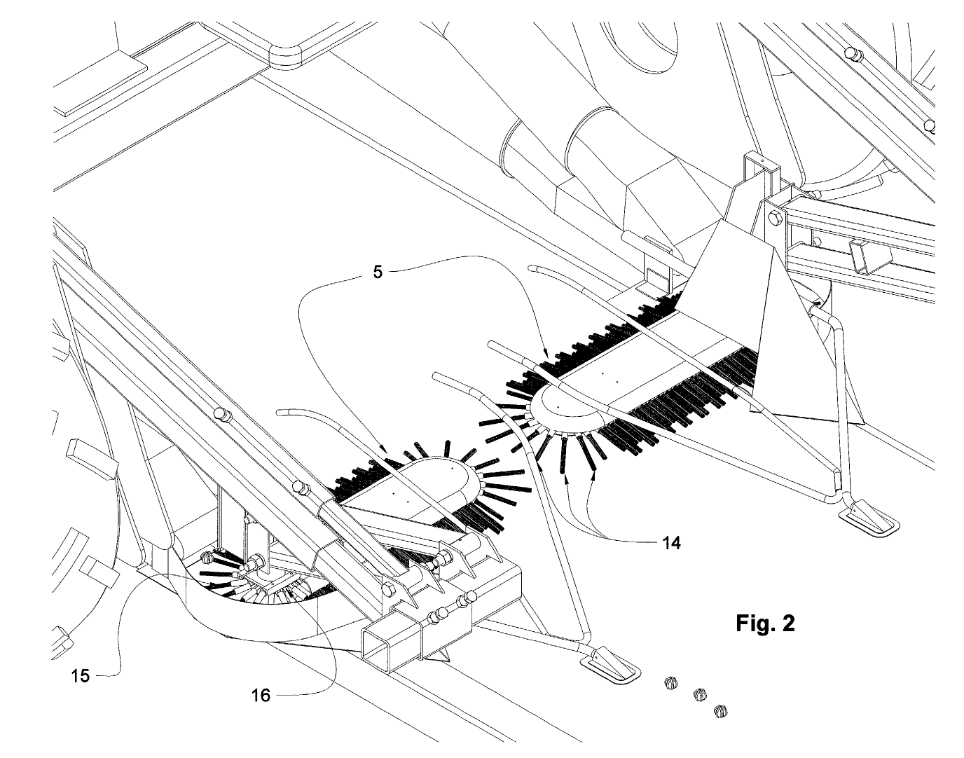

FIG. 2 Each of the pair of elongated rotating sweepers 5 is comprised of individual packets of whiskers 14 and each of said packet of whiskers 14 is attached to a chain assembly 15 similar to a chain saw, by means of easily obtainable electrical connectors 16 adapted to that purpose. Various means can procure rotation to the chain assembly 15 such as an hydraulic or electric motor, compressed air, or other such means.

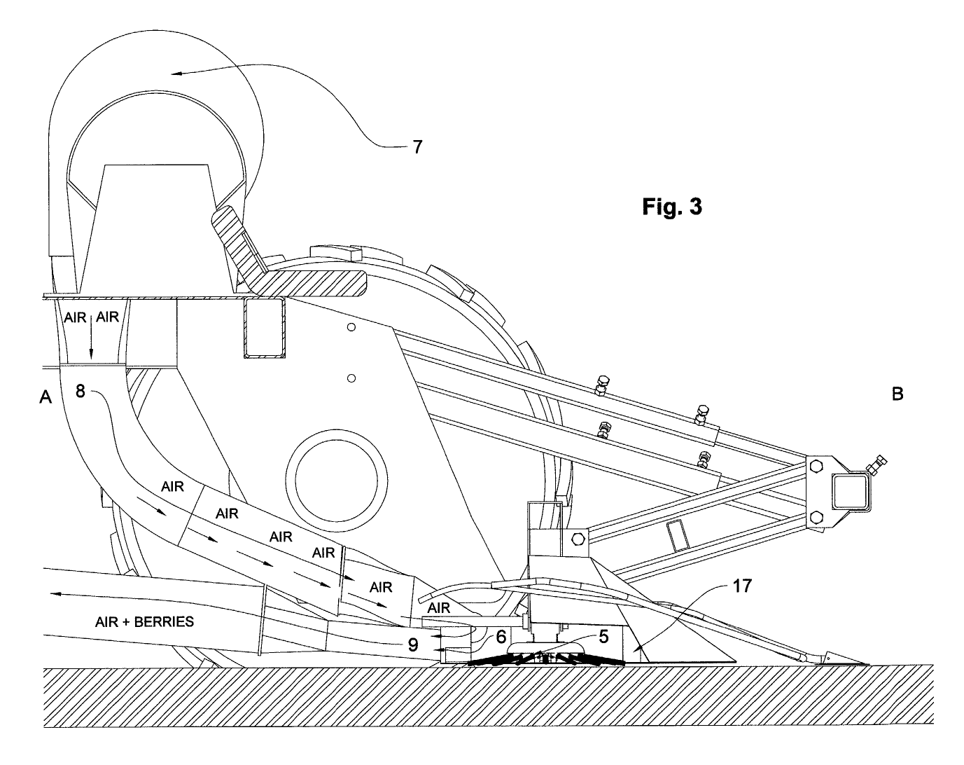

FIG. 3 The fruits 3 are carried by the elongated rotating sweepers 5 onto a bottom plate 17 and then, directly at the opening of the vacuum mouth 6, said vacuum mouth 6 is configured to generate a venturi effect which creates a vacuum that pulls the fruits 3 into the collector duct 9. Once in, the fruits 3 are subjected to the blowing effect of the air originally coming from the fans 7 (not shown) but redirected at the vacuum mouth 7. The advantage of using the venturi effect is that the fruits 3 are moved more slowly than when using suction, which results in less damage. Moreover, the path of the fruit is never in the way of the path of either one the fans 7(not shown)which are each situated at the other end of their respective air duct 8 (one shown).

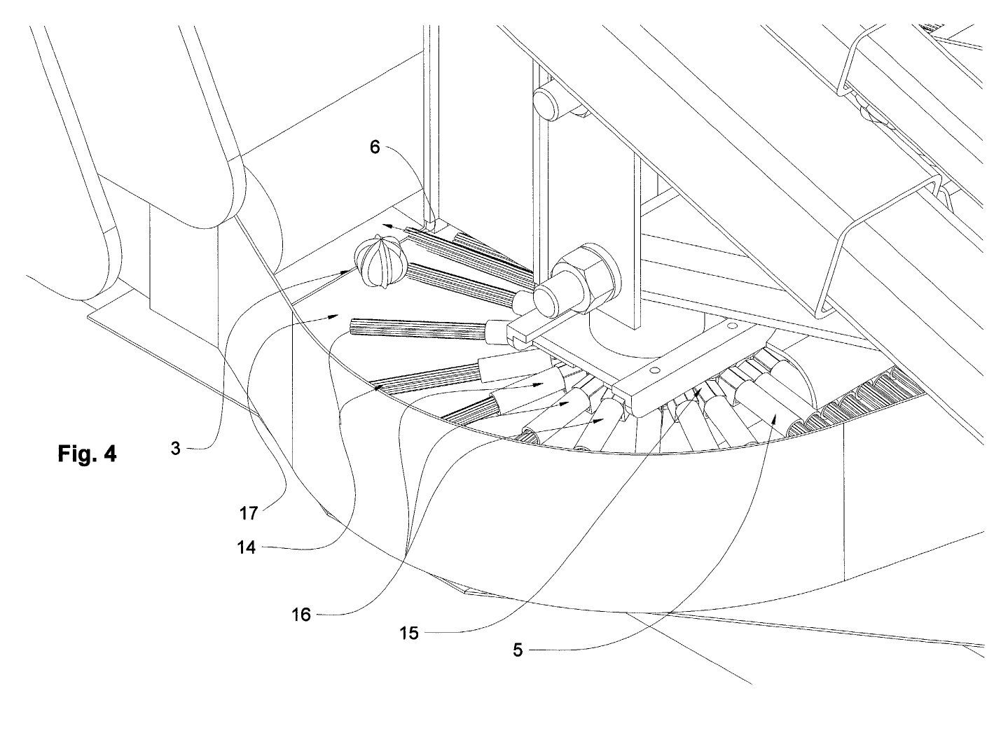

FIG. 4. A closer look at the elongated rotating sweeper 5 reveals the series of packets of whiskers 14 each attached to an electrical connector 16 and said electrical connectors 16 are all attached to a chain assembly 15. The fruits 3 are carried atop the bottom plate 17 around and in front of vacuum mouth 6.

What is claimed is:

1 A harvester for small fallen fruits which gathers fruits from the surface of a plastic mulch consists of
a conventional self propelled farm vehicle chassis equipped with a system of long protruding rods to lift up the leaves and branches of the fruit bearing shrubs that clear the way for a pair of elongated rotating sweepers and said elongated rotating sweepers direct the fruits into the mouth of an air duct which firstly collects the fruits at the said mouth using a venturi effect and then propels the said fruits using a blowing effect.

2 A harvester for small fallen fruits which gathers fruits from the surface of a plastic mulch as described in claim 1 has
low profile elongated rotating sweepers situated in the vicinity of the ground that limit the amount of lift of the leaves in order to reduce the damage to the shrubs.

3 A harvester for small fallen fruits which gathers fruits from the surface of a plastic mulch as described in claim 1 has
an air duct comprised of a blower nozzle which generates a venturi effect that creates a vacuum that propels the fruits into a collector duct.

4 A harvester for small fallen fruits which gathers fruits from the surface of a plastic mulch as described in claim 1 has
an air duct comprised of a blower nozzle and a fan which together generate a venturi effect that creates a vacuum that propels the fruits into a collector duct and said fruits in the said collector are never in the path of the fan.

5 A harvester for small fallen fruits which gathers fruits from the surface of a plastic mulch as described in claim 1 has
an air duct comprised of a blower nozzle which generates a venturi effect that creates a vacuum that propels the fruits into a collector duct and once in, the fruits are subjected to the blowing effect of the air from the said blower nozzle and are blown into a cleaning net that separates dirt and dust from the fruits.

6 A harvester for small fallen fruits which gathers fruits from the surface of a plastic mulch as described in claim 1 has
an air duct comprised of a blower nozzle which generates a venturi effect that creates a vacuum that propels the fruits into a collector duct and once in, the fruits are subjected to the blowing effect of the air from the said blower nozzle and are blown into a cleaning net that separates dirt and dust from the fruits and then the said fruits fall onto an inclined conveyor belt to remove leaves and twigs from the said fruits by having the said fruits roll down the conveyor belt until they reach the collector bin located at the bottom end while the leaves and twigs lay on the belt until discharged into a chute at the upper end of the said conveyor belt.
